(19) United States
(12) Patent Application Publication
(10) Pub. No.: US 2026/0044374 A1
(43) Pub. Date: Feb. 12, 2026

(54) DATA PROCESSING METHOD, APPARATUS, AND DEVICE, STORAGE MEDIUM, AND DISTRIBUTED CLUSTER

(71) Applicant: IEIT SYSTEMS (Beijing) Co., Ltd., Beijing (CN)

(72) Inventors: Yanwei WANG, Beijing (CN); Rengang LI, Beijing (CN); Hongwei KAN, Beijing (CN); Jiaheng FAN, Beijing (CN); Cheng HUANG, Beijing (CN); Junkai LIU, Beijing (CN)

(73) Assignee: IEIT SYSTEMS (Beijing) Co., Ltd., Beijing (CN)

(21) Appl. No.: 19/140,215

(22) PCT Filed: Sep. 26, 2024
(86) PCT No.: PCT/CN2024/121544

§ 371 Date: Jun. 17, 2025

(30) Foreign Application Priority Data
Oct. 25, 2023 (CN) 202311386368.1

(51) Int. Cl. G06F 9/50

(52) U.S. Cl. CPC G06F 9/5016

(57) ABSTRACT

The present application relates to the technical field of computers, and specifically discloses a data processing method, apparatus, and device, a storage medium, and a distributed cluster. Based on a compute express link (CXL) protocol, a memory of a first accelerator installed on a host becomes a shared memory, whereby when receiving a computing task, a host controller first switches a control right of the shared memory to a sender device to cause the sender device to write to-be-processed data of the computing task into the shared memory, then switches the control right to a second accelerator installed on the host to cause the second accelerator to read the to-be-processed data from the shared memory to complete the computing task, and switches the control right of the shared memory to the sender device or the host controller to read a computation result of the computing task from the shared memory.

### CROSS-REFERENCE TO RELATED APPLICATIONS

This application claims priority to Chinese Patent Application No. 202311386368.1, filed on Oct. 25, 2023 in China National Intellectual Property Administration and entitled “Data Processing Method, Apparatus, and Device, Storage Medium, and Distributed Cluster”, which is hereby incorporated by reference in its entirety.

### FIELD

The present application relates to the technical field of computers, and particularly to a data processing method, apparatus, and device, a storage medium, and a distributed cluster.

### BACKGROUND

With the development of artificial intelligence (AI), large-scale computing scenes are continuously increasing, leading to higher demands for the computing capability of devices. Therefore, a solution of installing accelerators as coprocessors of a central processing unit (CPU) on a host device has become a widely used technology. For example, a graphics processing unit (GPU) with a powerful computing capability may process a plurality of data sets simultaneously, which may significantly improve the computational efficiency of the device.

However, in the current solution of using the coprocessors to enhance the computing capability of the host, no matter to-be-processed data is written locally by a sender device or a computation result of a computing task is fed back to the sender device of the computing task, importing or exporting through a host memory is required. That is, in the solution of using the coprocessors to accelerate the computing of the host device, a data transmission path is added, which has become the bottleneck of the current coprocessor acceleration solution.

How to further improve the computational efficiency of the solution that the host uses coprocessors for acceleration is a technical problem to be solved by a person skilled in the art.

### SUMMARY

The present application provides a data processing method, which is applied to a host controller and includes:
switching, in response to receiving a computing task, a control right of a shared memory of a first accelerator installed on a host to a sender device of the computing task based on a compute express link (CXL) protocol to cause the sender device to write to-be-processed data of the computing task into the shared memory based on a remote direct memory access (RDMA) protocol;
switching the control right of the shared memory to a second accelerator installed on the host based on the CXL protocol to cause the second accelerator to read the to-be-processed data from the shared memory to execute the computing task and write a computation result into the shared memory; and
switching, in response to the second accelerator completing the computing task, the control right of the shared memory to the sender device based on the CXL protocol to cause the sender device to read the computation result from the shared memory based on the RDMA protocol, or switching the control right of the shared memory to the host controller based on the CXL protocol to cause the host controller to read the computation result from the shared memory.

In some implementations, switching the control right of the shared memory to the sender device based on the CXL protocol includes:
enabling an RDMA channel of the first accelerator based on the CXL protocol to connect the sender device to the shared memory based on the RDMA channel;
switching the control right of the shared memory to the second accelerator based on the CXL protocol includes:
enabling a channel of the first accelerator to the second accelerator based on the CXL protocol to connect the second accelerator to the shared memory based on the channel to the second accelerator;
switching the control right of the shared memory to the host controller based on the CXL protocol includes:
enabling a channel of the first accelerator to the host controller based on the CXL protocol to connect the host controller to the shared memory based on the channel to the host controller.

In other implementations, switching the control right of the shared memory to the sender device based on the CXL protocol includes:
enabling an RDMA module of the host, and controlling the first accelerator to connect the shared memory to the RDMA module based on the CXL protocol to connect the sender device to the shared memory based on the RDMA module.

In some implementations, switching the control right of the shared memory to the sender device based on the CXL protocol includes:
configuring, based on the CXL protocol, a parameter of a channel selection register of the shared memory in the first accelerator to switch the control right of the shared memory to the sender device;
switching the control right of the shared memory to the second accelerator based on the CXL protocol includes:
configuring, based on the CXL protocol, the parameter of the channel selection register of the shared memory in the first accelerator to switch the control right of the shared memory to the second accelerator;
switching the control right of the shared memory to the host controller based on the CXL protocol includes:
configuring, based on the CXL protocol, the parameter of the channel selection register of the shared memory in the first accelerator to switch the control right of the shared memory to the host controller.

In some implementations, the configuring, based on the CXL protocol, a parameter of a channel selection register of the shared memory in the first accelerator to switch the control right of the shared memory to the sender device includes:
configuring, based on the CXL protocol, the parameter of the channel selection register of the shared memory in the first accelerator to open a first data input/output (I/O) channel corresponding to the sender device and close a second data I/O channel corresponding to the second accelerator and a third data I/O channel corresponding to the host controller;
the configuring, based on the CXL protocol, the parameter of the channel selection register of the shared memory in the first accelerator to switch the control right of the shared memory to the second accelerator includes:
configuring, based on the CXL protocol, the parameter of the channel selection register of the shared memory in the first accelerator to open the second data I/O channel corresponding to the second accelerator and close the first data I/O channel corresponding to the sender device and the third data I/O channel corresponding to the host controller;
the configuring, based on the CXL protocol, the parameter of the channel selection register of the shared memory in the first accelerator to switch the control right of the shared memory to the host controller includes:
configuring, based on the CXL protocol, the parameter of the channel selection register of the shared memory in the first accelerator to open the third data I/O channel corresponding to the host controller and close the first data I/O channel corresponding to the sender device and the second data I/O channel corresponding to the second accelerator.

In other implementations, the configuring, based on the CXL protocol, a parameter of a channel selection register of the shared memory in the first accelerator to switch the control right of the shared memory to the sender device includes:
configuring, based on the CXL protocol, the parameter of the channel selection register of the shared memory in the first accelerator to switch a three-to-one channel switching switch in the first accelerator to conduct the sender device and the shared memory;
the configuring, based on the CXL protocol, the parameter of the channel selection register of the shared memory in the first accelerator to switch the control right of the shared memory to the second accelerator includes:
configuring, based on the CXL protocol, the parameter of the channel selection register of the shared memory in the first accelerator to switch the three-to-one channel switching switch in the first accelerator to conduct the second accelerator and the shared memory;
the configuring, based on the CXL protocol, the parameter of the channel selection register of the shared memory in the first accelerator to switch the control right of the shared memory to the host controller includes:
configuring, based on the CXL protocol, the parameter of the channel selection register of the shared memory in the first accelerator to switch the three-to-one channel switching switch in the first accelerator to conduct the host controller and the shared memory.

In some implementations, the shared memory is provided with a command cache area to write a read-write command to the shared memory into the command cache area when the sender device, the host controller, and the second accelerator do not have the control right of the shared memory.

In some implementations, the command cache area includes a first command cache area corresponding to the sender device, a second command cache area corresponding to the second accelerator, and a third command cache area corresponding to the host controller;
the writing a read-write command to the shared memory into the command cache area when the sender device, the host controller, and the second accelerator do not have the control right of the shared memory includes:
writing the read-write command to the shared memory into the corresponding command cache area when the sender device, the host controller, and the second accelerator do not have the control right of the shared memory, and writing the read-write command into the corresponding command cache area to cover a read-write command that is written earliest if the corresponding command cache area is fully written.

In some implementations, the method further includes:
configuring a size of the first command cache area, a size of the second command cache area, and a size of the third command cache area according to an operating environment of the host.

In some implementations, after obtaining the control right of the shared memory, the sender device, the host controller, and the second accelerator check the command cache area, and execute, if the command cache area stores a locally sent unexecuted read-write command, a new read-write command after executing the unexecuted read-write command.

In some implementations, the sender device, the host controller, and the second accelerator write a read-write command to the shared memory into a local command cache area when not having the control right of the shared memory.

In some implementations, the second accelerator reading the to-be-processed data from the shared memory to execute the computing task and writing a computation result into the shared memory includes:
reading, by the second accelerator, the to-be-processed data from the shared memory to a local cache, inputting the to-be-processed data into a pre-deployed kernel model to obtain the computation result, and writing the computation result into the shared memory,
where the kernel model is written by the host controller to the shared memory after the host controller switches the control right of the shared memory to the host controller based on the CXL protocol.

In some implementations, the switching, in response to receiving a computing task, a control right of a shared memory of a first accelerator installed on a host to a sender device of the computing task based on a CXL protocol to cause the sender device to write to-be-processed data of the computing task into the shared memory based on an RDMA protocol includes:
configuring, in response to receiving a processing request of the computing task, a channel selection register of the shared memory based on the CXL protocol to enable a first data I/O channel corresponding to an RDMA network interface, and configuring the RDMA network interface based on the CXL protocol to initiate the RDMA network interface to receive and write the to-be-processed data into the shared memory;
the switching the control right of the shared memory to a second accelerator installed on the host based on the CXL protocol to cause the second accelerator to read the to-be-processed data from the shared memory to execute the computing task and write a computation result into the shared memory includes:
configuring the channel selection register of the shared memory based on the CXL protocol to enable a third data I/O channel corresponding to the host controller to write a kernel model corresponding to the computing task into the shared memory based on the third data I/O channel; and
configuring the channel selection register of the shared memory based on the CXL protocol to enable a second data I/O channel corresponding to the second accelerator to cause the second accelerator to read the kernel model and the to-be-processed data from the shared memory to a local cache via the second data I/O channel to execute the computing task and write, after obtaining the computation result, the computation result into the shared memory based on the second data I/O channel;
the switching, in response to the second accelerator completing the computing task, the control right of the shared memory to the sender device based on the CXL protocol to cause the sender device to read the computation result from the shared memory based on the RDMA protocol includes:
configuring, in response to receiving information of completing the computing task fed back by the second accelerator, the channel selection register of the shared memory based on the CXL protocol to enable the first data I/O channel, and configuring the RDMA network interface based on the CXL protocol to cause the sender device to read the computation result from the shared memory based on the RDMA protocol;
the switching the control right of the shared memory to the host controller based on the CXL protocol to cause the host controller to read the computation result from the shared memory includes:
configuring, in response to receiving the information of completing the computing task fed back by the second accelerator, the channel selection register of the shared memory based on the CXL protocol to enable the third data I/O channel to read the computation result from the shared memory to the host controller based on the third data I/O channel.

In some implementations, the first accelerator is a field-programmable gate array (FPGA) supporting the CXL protocol and having an extended memory or an application specific integrated circuit (ASIC) supporting the CXL protocol and having an extended memory, and the second accelerator is a GPU; the extended memory serves as the shared memory of the first accelerator.

In some implementations, a plurality of GPUs share the shared memory of the same first accelerator.

The present application further provides a data processing method, which is applied to a first accelerator of a host and includes:
switching, in response to receiving a first switching command sent by a host controller of the host based on a CXL protocol, a control right of a shared memory of the first accelerator to a sender device of a computing task to cause the sender device to write to-be-processed data of the computing task into the shared memory based on an RDMA protocol;
switching, in response to receiving a second switching command sent by the host controller based on the CXL protocol, the control right of the shared memory to a second accelerator installed on the host to cause the second accelerator to read the to-be-processed data from the shared memory to execute the computing task and write a computation result into the shared memory; and
switching, in response to receiving the first switching command sent by the host controller when the second accelerator completes the computing task based on the CXL protocol, the control right of the shared memory of the first accelerator to the sender device to cause the sender device to read the computation result from the shared memory based on the RDMA protocol; or switching, in response to receiving a third switching command sent by the host controller when the second accelerator completes the computing task based on CXL protocol, the control right of the shared memory of the first accelerator to the host controller to cause the host controller to read the computation result from the shared memory.

In some implementations, the shared memory is provided with a command cache area to write a read-write command to the shared memory into the command cache area when the sender device, the host controller, and the second accelerator do not have the control right of the shared memory.

The present application further provides a data processing method, which is applied to a second accelerator of a host and includes:
reading, in response to receiving a computing task starting signal and obtaining a control right of a shared memory of a first accelerator installed on the host, to-be-processed data of a computing task from the shared memory to execute the computing task, and writing a computation result into the shared memory; and
notifying, in response to completing the computing task, a host controller of information of completing the computing task to cause the host controller to switch the control right of the shared memory to a sender device of the computing task based on a CXL protocol to cause the sender device to read the computation result from the shared memory based on an RDMA protocol, or switch the control right of the shared memory to the host controller based on the CXL protocol to cause the host controller to read the computation result from the shared memory,
where the to-be-processed data is written to the shared memory by the sender device based on the RDMA protocol after the host controller switches the control right of the shared memory to the sender device based on the CXL protocol.

The present application further provides a data processing device, including a host controller, a first accelerator, and a second accelerator,
where the first accelerator establishes a CXL channel with the host controller based on a CXL protocol to realize a shared memory of the first accelerator;
the host controller is configured to switch, when receiving a computing task, a control right of the shared memory to a sender device of the computing task based on the CXL protocol to cause the sender device to write to-be-processed data of the computing task into the shared memory based on a RDMA protocol; switch the control right of the shared memory to the second accelerator based on the CXL protocol to cause the second accelerator to read the to-be-processed data from the shared memory to execute the computing task and write a computation result into the shared memory; and switch, in response to the second accelerator completing the computing task, the control right of the shared memory to the sender device based on the CXL protocol to cause the sender device to read the computation result from the shared memory based on the RDMA protocol, or switch the control right of the shared memory to the host controller based on the CXL protocol to cause the host controller to read the computation result from the shared memory.

The present application further provides a distributed cluster including a plurality of data processing devices as described above.

The present application further provides a data processing apparatus, which is applied to a host controller and includes:
a task receiving control unit configured to switch, in response to receiving a computing task, a control right of a shared memory of a first accelerator installed on a host to a sender device of the computing task based on a CXL protocol to cause the sender device to write to-be-processed data of the computing task into the shared memory based on a RDMA protocol;
a computation control unit configured to switch the control right of the shared memory to a second accelerator installed on the host based on the CXL protocol to cause the second accelerator to read the to-be-processed data from the shared memory to execute the computing task and write a computation result into the shared memory; and
a result acquisition control unit configured to switch, in response to the second accelerator completing the computing task, the control right of the shared memory to the sender device based on the CXL protocol to cause the sender device to read the computation result from the shared memory based on the RDMA protocol, or switch the control right of the shared memory to the host controller based on the CXL protocol to cause the host controller to read the computation result from the shared memory.

The present application further provides a data processing device, including:
a memory configured to store a computer-readable instruction; and
a processor configured to execute the computer-readable instruction which, when executed by the processor, implements the steps of the data processing method according to any one of the foregoing implementations.

The present application further provides one or more non-volatile computer-readable storage media, storing a computer-readable instruction which, when executed by one or more processors, causes the one or more processors to perform the steps of the data processing method according to any one of the foregoing implementations.

### BRIEF DESCRIPTION OF THE DRAWINGS

To more clearly illustrate the technical solutions in the embodiments of the present application or in the related art, the drawings required in the descriptions of the embodiments or the related art will be briefly introduced below. Obviously, the drawings described below are only some embodiments of the present application, and a person skilled in the art may obtain other drawings according to these drawings without involving any inventive effort.

FIG. 1 is a schematic diagram of a scene for host computing acceleration based on a GPU;

FIG. 2 is a schematic structural diagram of a data processing device provided by one or more embodiments of the present application;

FIG. 3 is a schematic diagram of a data processing scene based on a data processing device provided by one or more embodiments of the present application;

FIG. 4 is a flowchart of a data processing method provided by one or more embodiments of the present application;

FIG. 5 is a flowchart of another data processing method provided by one or more embodiments of the present application;

FIG. 6 is a flowchart of yet another data processing method provided by one or more embodiments of the present application;

FIG. 7 is a schematic structural diagram of a data processing apparatus provided by one or more embodiments of the present application; and

FIG. 8 is a schematic structural diagram of another data processing device provided by one or more embodiments of the present application.

### DETAILED DESCRIPTION

The core of the present application is to provide a data processing method, apparatus, and device, a storage medium, and a distributed cluster for improving the computational efficiency of a solution that a host uses coprocessors for acceleration.

The technical solutions in the embodiments of the present application will be clearly and completely described below in combination with the accompanying drawings in the embodiments of the present application. Obviously, the described embodiments are only some embodiments of the present application, not all embodiments. All other embodiments obtained by a person skilled in the art based on the embodiments of the present application without inventive efforts fall within the scope of the present application.

Embodiment 1 of the present application is described below.

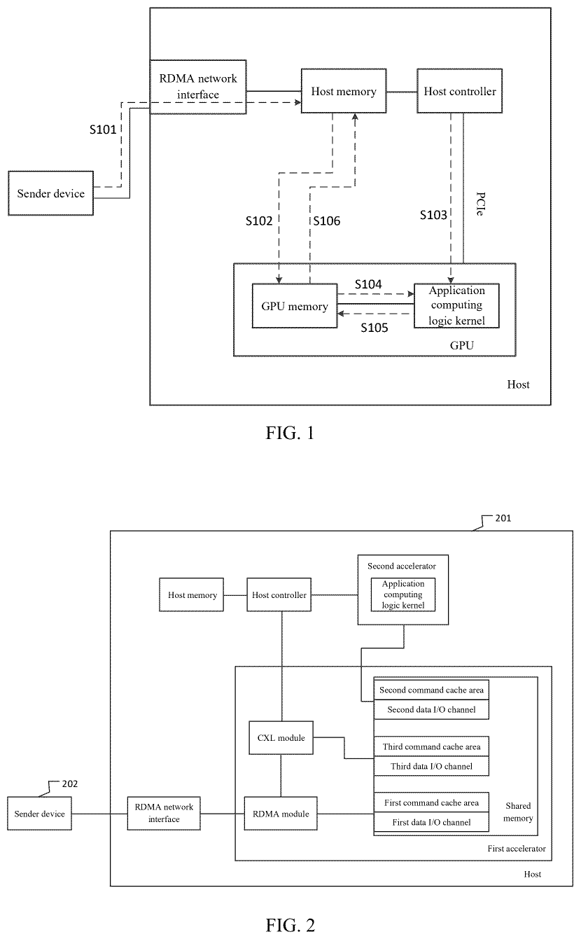

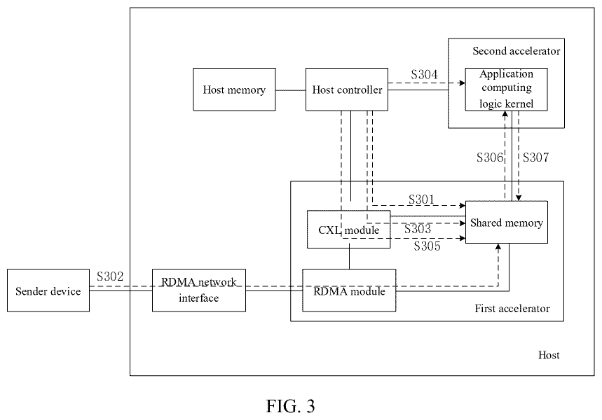

FIG. 1 is a schematic diagram of a scene for host computing acceleration based on a GPU. FIG. 2 is a schematic structural diagram of a data processing device provided by an embodiment of the present application. FIG. 3 is a schematic diagram of a data processing scene based on a data processing device provided by an embodiment of the present application.

For ease of understanding, the data processing device provided by an embodiment of the present application is first described.

As shown in FIG. 1, taking a GPU as a coprocessor of a host controller as an example, in a traditional coprocessor acceleration solution, the host controller is usually a CPU, which serves as a center for controlling the execution of computing tasks. A coprocessor is installed on a peripheral component interconnect express (PCIe) interface of the host, whereby the host controller and the GPU are connected through the PCIe. A complete procedure of executing a computing task mainly includes:
S101: receiving, by the host controller, to-be-processed data provided by a sender device (data acquisition server) through an RDMA network interface and storing the to-be-processed data in a host memory;
S102: controlling, by the host controller, to copy the to-be-processed data in the host memory to a GPU memory;
S103: deploying, by the host controller, a kernel program (kernel model) corresponding to the computing task in an application computing logic kernel of the GPU, this step having no sequential relationship with S102;
S104: reading, by the application computing logic kernel of the GPU, the to-be-processed data from the GPU memory and inputting the to-be-processed data into a kernel program for computing to obtain a computation result;
S105: storing, by the application computing logic kernel of the GPU, the computation result in the GPU memory; and
S106: copying, by the host controller, the computation result from the GPU memory to the host memory.

It can be seen that, although the RDMA technology is adopted to achieve rapid data transmission between the sender device and the host, when the computing task is executed in the host, a data transmission path is long due to the need to move input data and output data between the host memory and the coprocessor memory, which is the bottleneck affecting the efficiency of the solution that the coprocessor is adopted to accelerate the computing.

To further improve the computational efficiency of the solution that the host uses coprocessors for acceleration, as shown in FIG. 2, an embodiment of the present application provides a data processing device, including a host controller, a first accelerator, and a second accelerator.

The first accelerator establishes a CXL channel with the host controller based on a CXL protocol to realize a shared memory of the first accelerator.

The host controller is configured to switch, when receiving a computing task, a control right of the shared memory to a sender device of the computing task based on the CXL protocol to cause the sender device to write to-be-processed data of the computing task into the shared memory based on a RDMA protocol; switch the control right of the shared memory to the second accelerator based on the CXL protocol to cause the second accelerator to read the to-be-processed data from the shared memory to execute the computing task and write a computation result into the shared memory; and switch, in response to the second accelerator completing the computing task, the control right of the shared memory to the sender device based on the CXL protocol to cause the sender device to read the computation result from the shared memory based on the RDMA protocol, or switch the control right of the shared memory to the host controller based on the CXL protocol to cause the host controller to read the computation result from the shared memory.

It should be noted that, in various embodiments of the present application, the first accelerator is defined as an accelerator device supporting the CXL protocol and having a memory storage capable of serving as the shared memory. The second accelerator is an accelerator device configured to actually execute the computing task. In practical application, the first accelerator and the second accelerator on the host may be the same accelerator, or may be different accelerators. The first accelerator may be one or more of an FPGA and an ASIC, and the second accelerator may be one or more of a GPU, an FPGA, an ASIC, and a data processing unit (DPU). In various embodiments of the present application, the host controller may be a CPU, or may be another type of controller configured to control the overall computing procedure.

To realize that the memory of the first accelerator serves as the shared memory of the sender device, the host controller, and the second accelerator, it is not only necessary to establish the CXL channel between the first accelerator and the host controller based on the CXL protocol, but also necessary to establish an RDMA channel between the host and the sender device based on the RDMA protocol, whereby the sender device can directly write the data into the shared memory of the host without passing through the main memory. In addition, both the host controller and the second accelerator may directly access the shared memory to obtain data without the need to move the data between the host memory and the memory of the second accelerator.

CXL is a high-speed interconnection technology intended to provide high-performance, low-latency, and high-concurrency connectivity and data transmission capabilities. In the CXL specification, three types of devices applicable to the CXL protocol are defined. (1) A device that wants to locally cache data from a main memory of the CPU is defined. In this case, the device only needs to use a CXL I/O (CXL.I/O) protocol and a CXL cache (CXL.cache) protocol. (2) A device that has a memory on the accelerator and requires interaction between the CPU and the accelerator is defined. Therefore, the CXL.I/O protocol is used to allow the CPU to discover and configure the device, then the CXL.cache protocol is used to allow the device to access the memory of the CPU, and a CXL memory (CXL.mem) protocol is used to allow the CPU to access the memory of the device. (3) A memory buffer is defined. In this case, the CXL.I/O protocol is required to discover and configure the device, and the CXL.mem protocol is required to allow processors such as the CPU to access a memory connected to the memory buffer. The third CXL device (Type3) may expand the memory under the CXL protocol, whereby the host controller may use the memory of the device indiscriminately. However, in the embodiment of the present application, it is also necessary for a remote sender device to use the shared memory of the first accelerator. Therefore, the host controls the RDMA network interface and the shared memory of the first accelerator through a CXL bus, whereby these two modules may work under the control of the host controller.

As shown in FIG. 2, a host 201 and a sender device 202 configured to provide the to-be-processed data of the computing task are connected based on the RDMA, and specifically communicated through an RDMA network interface of the two, so as to realize memory-to-memory data transmission between the host 201 and the sender device 202.

In the host computer 201, the first accelerator supporting the CXL protocol and capable of providing the shared memory is adopted, and the kernel of the first accelerator is logically divided to obtain a CXL module configured to control the shared memory and an RDMA module configured to connect to the RDMA network interface of the host. The CXL channel between the host controller and the first accelerator is established based on the CXL module, whereby the host controller may realize switching control of the control right of the shared memory based on the CXL channel. The control right of the shared memory primarily determines the configuration of read operations, write operations, and other parameters to the shared memory (for example, a size of a storage region is divided to perform a particular data storage operation). To maintain memory consistency, it is required to set that only one subject (sender device, second accelerator, or host controller) can perform the write operation on a data storage area of the shared memory at a moment. In the first accelerator, the CXL module and the RDMA module may each be connected to the shared memory through a memory mapped bus (AVMM bus).

The host controller is connected to the second accelerator through the PCIe, and the second accelerator is connected to the shared memory of the first accelerator through a memory storage interface (e.g., a double-data-rate (DDR) synchronous dynamic random access memory interface). The second accelerator executes the computing task, and a kernel program (kernel model) corresponding to the computing task needs to be deployed in an application computing kernel of the second accelerator to perform computation based on the to-be-processed data of the computing task provided by the sender device. In practical application, the kernel program is usually provided by the host controller, while the to-be-processed data of the computing task is provided by the remote sender device. After deploying a kernel model with a configured kernel parameter, the second accelerator inputs the to-be-processed data into the kernel model to execute the computing task and obtain the computation result.

Then, as shown in FIG. 3, a complete procedure of executing a computing task using the data processing device provided by the embodiment of the present application mainly includes:
S301: controlling, by the host, to switch the control right of the shared memory to a first data I/O channel connecting an RDMA channel and the shared memory through the CXL module;
S302: writing, by the remote sender device, the to-be-processed data of the computing task into the shared memory of the host based on the RDMA protocol;
S303: controlling, by the host, to switch the control right of the shared memory to a third data I/O channel between the host controller and the shared memory through the CXL channel and writing the kernel program (kernel model) corresponding to the computing task into the shared memory based on a second data I/O channel; or
S304: deploying, by the host controller, the kernel program (kernel model) corresponding to the computing task in the application computing logic kernel of the second accelerator; selecting one of S303 and S304 to perform;
S305: controlling, by the host, to switch the control right of the shared memory to the second data I/O channel between the second accelerator and the shared memory through the CXL channel;
S306: reading, by the second accelerator, the to-be-processed data (and the kernel program) from the shared memory, and after deploying the kernel program with the configured kernel parameter, inputting the to-be-processed data into the kernel program to execute the computing task and obtain the computation result; and
S307: writing, by the second accelerator, the computation result into the shared memory.

The host controller interacts with the second accelerator to monitor the process of the second accelerator executing the computing task. For example, the second accelerator may be designed to send an interrupt signal to the host controller after completing the computing task, and the host controller determines that the second accelerator completes the computing task after receiving the interrupt signal of the second accelerator, whereby the host controller may control to switch the control right of the shared memory back to the first data I/O channel through the CXL channel and notify the sender device to read the computation result in the shared memory through the first data I/O channel. Alternatively, the host controller may control to switch the control right of the shared memory to the host controller based on the CXL channel to connect the third data I/O channel between the host controller and the shared memory to enable the host controller to read the computation result from the shared memory on its own.

According to the data processing device provided by the embodiment of the present application, during the transmission of input data and input/output data related to the computing task, there is no need to move the data between the host memory and the memory of the second accelerator configured to execute the computing task. That is, in the accelerator solution, data inputting and data outputting are both performed directly based on the shared memory, and the path for data importing and exporting is significantly shortened, thereby improving the data processing efficiency of the accelerator solution.

On this basis, to prevent the sender device, the host controller, or the second accelerator from generating a read-write demand to the shared memory when the control right of the shared memory is not obtained, a command cache area for caching a read-write command to the shared memory when the sender device, the host controller, and the second accelerator do not have the control right of the shared memory may also be provided in the shared memory. For balanced management, the command cache area may be divided into a first command cache area corresponding to the sender device, a second command cache area corresponding to the second accelerator, and a third command cache area corresponding to the host controller. An overall size of the command cache area or a size of each command cache area may be configured according to a control environment of the host. When obtaining the control right of the shared memory, the sender device, the host controller, and the second accelerator may first check whether a corresponding command cache area stores a locally sent unexecuted read-write command, and if so, execute a new read-write command after executing the unexecuted read-write command.

Embodiment 2 of the present application is described below.

Based on the above-mentioned embodiment, the embodiment of the present application further provides a distributed cluster. The distributed cluster includes a plurality of data processing devices as described in the above-mentioned embodiment. An Remote Direct Memory Access (RDMA) channel may be established between the data processing devices to achieve mutual data forwarding and load balancing. Further, a CXL channel may be established between the data processing devices based on a CXL protocol to further improve the efficiency of data forwarding and load balancing between the data processing devices. In the face of a large-scale computing scene, a remote sender device distributes a plurality of computing tasks to hosts in the distributed cluster. During the execution of the computing task, each host may offload the computing task to other hosts for execution through load balancing when under heavy loads.

Based on the architecture of the above-mentioned data processing device, the data processing method provided by the embodiment of the present application is described below in combination with the accompanying drawings.

Embodiment 3 of the present application is described below.

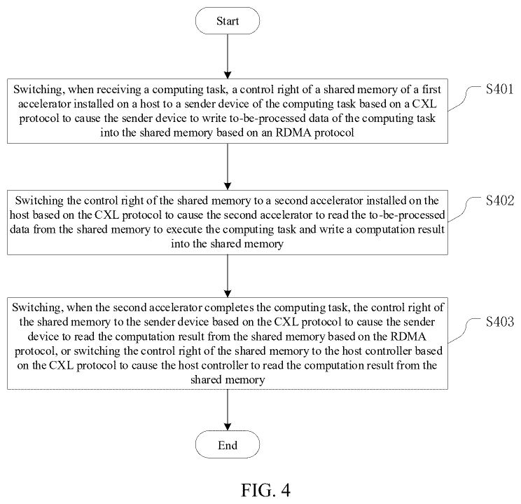

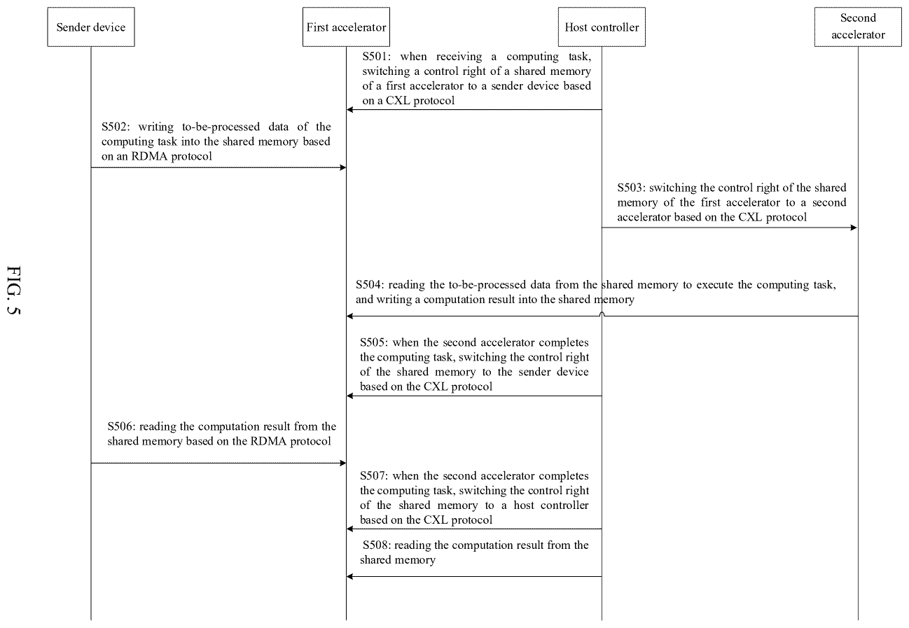

FIG. 4 is a flowchart of a data processing method provided by an embodiment of the present application. FIG. 5 is a flowchart of another data processing method provided by an embodiment of the present application.

As shown in FIG. 4, when applied to a host controller, the data processing method provided by the embodiment of the present application includes:
S401: switching, when receiving a computing task, a control right of a shared memory of a first accelerator installed on a host to a sender device of the computing task based on a CXL protocol to cause the sender device to write to-be-processed data of the computing task into the shared memory based on an RDMA protocol;
S402: switching the control right of the shared memory to a second accelerator installed on the host based on the CXL protocol to cause the second accelerator to read the to-be-processed data from the shared memory to execute the computing task and write a computation result into the shared memory; and
S403: switching, when the second accelerator completes the computing task, the control right of the shared memory to the sender device based on the CXL protocol to cause the sender device to read the computation result from the shared memory based on the RDMA protocol, or switching the control right of the shared memory to the host controller based on the CXL protocol to cause the host controller to read the computation result from the shared memory. In the embodiment of the present application, as described in the above-mentioned embodiments of the present application, the first accelerator is an accelerator device supporting the CXL protocol and having a memory storage capable of serving as the shared memory, and may be one or more of an Field-Programmable Gate Array (FPGA) and an Application Specific Integrated Circuit (ASIC). The second accelerator is an accelerator device configured to actually execute the computing task, and may be one or more of a Graphics Processing Unit (GPU), an FPGA, an ASIC, and a Data Processing Unit (DPU). The host controller may be a Central Processing Unit (CPU), or may be another type of controller configured to control the overall computing procedure. In practical application, the first accelerator and the second accelerator may be the same accelerator, or different accelerators.

In practical application, the first accelerator may be a FPGA supporting the CXL protocol and having an extended memory or an ASIC supporting the CXL protocol and having an extended memory, and the second accelerator is a GPU. The extended memory serves as the shared memory of the first accelerator.

In various embodiments of the present application, it may be provided that a plurality of GPUs share the shared memory of the same first accelerator, in combination with the size of the shared memory that the first accelerator can provide and the computation requirement of the second accelerator.

According to the description of the above-mentioned embodiments, to realize that the memory of the first accelerator serves as the shared memory of the sender device, the host controller, and the second accelerator, it is not only necessary to establish the CXL channel between the first accelerator and the host controller based on the CXL protocol, but also necessary to establish an RDMA channel between the host and the sender device based on the RDMA protocol. To realize the RDMA function, a connection may be established with the RDMA network interface of the host through an RDMA module configured in the first accelerator, or a connection may be established with the RDMA network interface through the first accelerator and an external RDMA module.

According to the data processing method provided by the above-mentioned embodiment, based on the CXL protocol, the memory of the first accelerator installed on the host becomes the shared memory, whereby when receiving the computing task, the host controller first switches the control right of the shared memory to the sender device to cause the sender device to write the to-be-processed data of the computing task into the shared memory, then switches the control right to the second accelerator installed on the host to cause the second accelerator to read the to-be-processed data from the shared memory to complete the computing task, and switches the control right of the shared memory to the sender device or the host controller to read the computation result of the computing task from the shared memory. Therefore, in the accelerator solution, data inputting and data outputting are both performed directly based on the shared memory, and there is no need to move the data between the host memory and the accelerator memory. Thus, the path for data importing and exporting is shortened, thereby improving the data processing efficiency of the accelerator solution.

In combination with the data processing device provided in FIG. 2, as shown in FIG. 5, based on the host controller, the first accelerator, and the second accelerator, a data processing method provided by the embodiment of the present application includes:
S501: when receiving a computing task, switching, by the host controller, the control right of the shared memory of the first accelerator to the sender device based on the CXL protocol;
S502: writing, by the sender device, the to-be-processed data of the computing task into the shared memory based on the RDMA protocol;
S503: switching, by the host controller, the control right of the shared memory of the first accelerator to the second accelerator based on the CXL protocol;
S504: reading, by the second accelerator, the to-be-processed data from the shared memory to execute the computing task, and writing a computation result into the shared memory;
S505: when the second accelerator completes the computing task, switching, by the host controller, the control right of the shared memory to the sender device based on the CXL protocol;
S506: reading, by the sender device, the computation result from the shared memory based on the RDMA protocol;
S507: when the second accelerator completes the computing task, switching, by the host controller, the control right of the shared memory to the host controller based on the CXL protocol; and
S508: reading, by the host controller, the computation result from the shared memory.

It should be noted that one of S505 and S506 is selected to perform, and one of S507 and S508 is selected to perform.

If the first accelerator has the RDMA module, switching the control right of the shared memory to the sender device based on the CXL protocol in S401 includes: enabling an RDMA channel of the first accelerator based on the CXL protocol to connect the sender device to the shared memory based on the RDMA channel. Switching the control right of the shared memory to the second accelerator based on the CXL protocol in S402 includes: enabling a channel of the first accelerator to the second accelerator based on the CXL protocol to connect the second accelerator to the shared memory based on the channel to the second accelerator. Switching the control right of the shared memory to the host controller based on the CXL protocol in S403 includes: enabling a channel of the first accelerator to the host controller based on the CXL protocol to connect the host controller to the shared memory based on the channel to the host controller.

If an RDMA module based on the host is used, switching the control right of the shared memory to the sender device based on the CXL protocol in S401 includes: enabling an RDMA network interface of the host, and controlling the first accelerator to connect the shared memory to the RDMA network interface based on the CXL protocol to connect the sender device to the shared memory based on the RDMA network interface.

For S401, when receiving the information of the computing task sent by the remote sender device, the host controller switches the control right of the shared memory of the first accelerator to the sender device based on the CXL channel constituted by the CXL module to cause the sender device to write the to-be-processed data of the computing task into the shared memory based on the RDMA protocol.

For S402, after determining that the sender device has finished writing the to-be-processed data, the host controller switches the control right of the shared memory to the second accelerator based on the CXL channel to cause an application computing logic kernel of the second accelerator to read the to-be-processed data from the shared memory to execute the computing task and obtain the computation result. To have the capability of executing the computing task, the second accelerator needs to be pre-deployed with a kernel program corresponding to the computing task, and the host controller may write the kernel program into the memory of the second accelerator through the PCIe for the application computing logic kernel of the second accelerator to read, or the host controller switches the control right of the shared memory to the host controller based on the CXL channel and writes the kernel program into the shared memory to cause the second accelerator to read the kernel program and the to-be-processed data together from the shared memory.

Then, the second accelerator reading the to-be-processed data from the shared memory to execute the computing task and writing the computation result into the shared memory in S402 may include: reading, by the second accelerator, the to-be-processed data from the shared memory to a local cache, inputting the to-be-processed data into a pre-deployed kernel model to obtain the computation result, and writing the computation result into the shared memory, where the kernel model is written by the host controller to the shared memory after the host controller switches the control right of the shared memory to the host controller based on the CXL protocol.

For S403, the host controller interacts with the second accelerator to monitor the process of the second accelerator executing the computing task. For example, the second accelerator may be designed to send an interrupt signal to the host controller after completing the computing task, and the host controller determines that the second accelerator completes the computing task after receiving the interrupt signal of the second accelerator, whereby the host controller may control to switch the control right of the shared memory back to the first data I/O channel through the CXL channel and notify the sender device to read the computation result in the shared memory through the first data I/O channel. Alternatively, the host controller may control to switch the control right of the shared memory to the host controller based on the CXL channel to connect the third data I/O channel between the host controller and the shared memory to enable the host controller to read the computation result from the shared memory on its own.

It should be noted that in addition to configuring the control right of the shared memory through the CXL channel, the host controller may further read and write the shared memory based on the CXL channel after obtaining the control right of the shared memory. That is, when the host controller does not have the control right of the shared memory, the host controller still controls the switching of the control right of the shared memory.

According to the data processing method provided by the embodiment of the present application, based on the CXL protocol, the memory of the first accelerator installed on the host becomes the shared memory, whereby when receiving the computing task, the host controller first switches the control right of the shared memory to the sender device to cause the sender device to write the to-be-processed data of the computing task into the shared memory, then switches the control right to the second accelerator installed on the host to cause the second accelerator to read the to-be-processed data from the shared memory to complete the computing task, and switches the control right of the shared memory to the sender device or the host controller to read the computation result of the computing task from the shared memory. Therefore, in the accelerator solution, data inputting and data outputting are both performed directly based on the shared memory, and there is no need to move the data between the host memory and the accelerator memory. Thus, the path for data importing and exporting is shortened, thereby improving the data processing efficiency of the accelerator solution.

Embodiment 4 of the present application is described below.

Based on the above-mentioned embodiments, the embodiment of the present application further provides a solution that the host controller controls the switching of the control right of the shared memory.

In the data processing method provided by the embodiment of the present application, switching the control right of the shared memory to the sender device based on the CXL protocol in S401 may include:
configuring, based on the CXL protocol, a parameter of a channel selection register of the shared memory in the first accelerator to switch the control right of the shared memory to the sender device.

Switching the control right of the shared memory to the second accelerator based on the CXL protocol in S402 may include:
configuring, based on the CXL protocol, the parameter of the channel selection register of the shared memory in the first accelerator to switch the control right of the shared memory to the second accelerator.

Switching the control right of the shared memory to the host controller based on the CXL protocol in S403 may include:
configuring, based on the CXL protocol, the parameter of the channel selection register of the shared memory in the first accelerator to switch the control right of the shared memory to the host controller.

In a specific implementation, referring to FIG. 2, to implement the three-to-one channel function for the shared memory, the channel selection register (channel selector) may be deployed in the shared memory to implement the switching logic of the control right of the shared memory.

The channel selection register may be implemented with logic to configure switches of the corresponding data I/O channels. Then, the configuring, based on the CXL protocol, a parameter of a channel selection register of the shared memory in the first accelerator to switch the control right of the shared memory to the sender device may include:
configuring, based on the CXL protocol, the parameter of the channel selection register of the shared memory in the first accelerator to open a first data I/O channel corresponding to the sender device and close a second data I/O channel corresponding to the second accelerator and a third data I/O channel corresponding to the host controller.

The configuring, based on the CXL protocol, the parameter of the channel selection register of the shared memory in the first accelerator to switch the control right of the shared memory to the second accelerator may include:
configuring, based on the CXL protocol, the parameter of the channel selection register of the shared memory in the first accelerator to open the second data I/O channel corresponding to the second accelerator and close the first data I/O channel corresponding to the sender device and the third data I/O channel corresponding to the host controller.

The configuring, based on the CXL protocol, the parameter of the channel selection register of the shared memory in the first accelerator to switch the control right of the shared memory to the host controller may include:
configuring, based on the CXL protocol, the parameter of the channel selection register of the shared memory in the first accelerator to open the third data I/O channel corresponding to the host controller and close the first data I/O channel corresponding to the sender device and the second data I/O channel corresponding to the second accelerator.

That is, the channel selection register includes a channel selection register corresponding to the data I/O channels (including the first data I/O channel, the second data I/O channel, and the third data I/O channel), and the host controller configures the parameters of the channel selection register corresponding to the data I/O channels (including the first data I/O channel, the second data I/O channel, and the third data I/O channel) to conduct only one data I/O channel at a moment, so as to enable a corresponding control subject to obtain a read-write right to the shared memory. Thus, the channel selection register is deployed in the shared memory of the first accelerator to configure the switch states of the data I/O channels, and the host controller controls the switch states of the data I/O channels by configuring the parameters of the channel selection register.

Embodiment 5 of the present application is described below.

Based on the above-mentioned embodiments, the embodiment of the present application provides another solution that the host controller controls the switching of the control right of the shared memory.

In the data processing method provided by the embodiment of the present application, the configuring, based on the CXL protocol, a parameter of a channel selection register of the shared memory in the first accelerator to switch the control right of the shared memory to the sender device may include:
configuring, based on the CXL protocol, the parameter of the channel selection register of the shared memory in the first accelerator to switch a three-to-one channel switching switch in the first accelerator to conduct the sender device and the shared memory.

The configuring, based on the CXL protocol, the parameter of the channel selection register of the shared memory in the first accelerator to switch the control right of the shared memory to the second accelerator may include:
configuring, based on the CXL protocol, the parameter of the channel selection register of the shared memory in the first accelerator to switch the three-to-one channel switching switch in the first accelerator to conduct the second accelerator and the shared memory.

The configuring, based on the CXL protocol, the parameter of the channel selection register of the shared memory in the first accelerator to switch the control right of the shared memory to the host controller may include:
configuring, based on the CXL protocol, the parameter of the channel selection register of the shared memory in the first accelerator to switch the three-to-one channel switching switch in the first accelerator to conduct the host controller and the shared memory.

In addition to the logic described in the above-mentioned embodiment that the host controller controls the switch states of the data I/O channels by configuring the parameters of the channel selection register and controls only one data I/O channel to be opened at a time, referring to FIG. 2, the channel selection register (channel selector) may further be deployed in the shared memory as described in the embodiment of the present application. The channel selection register includes a channel selection register and a three-to-one channel switching switch. Three first ends of the three-to-one channel switching switch are connected to the sender device, the second accelerator, and the host controller, respectively, and a second end of the three-to-one channel switching switch is connected to a writing interface of the shared memory, whereby the host controller only needs to configure the parameters of the channel selection register to set the conduction state of the current three-to-one channel switching switch. Thus, the logic of only opening one data I/O channel at a time may be realized.

Embodiment 6 of the present application is described below.

Based on the above-mentioned embodiments, to prevent the problem that the sender device, the host controller, or the second accelerator generates a read-write demand to the shared memory when the control right of the shared memory is not obtained, and a generated read-write command cannot be executed and are lost, resulting in data loss, in the data processing method provided by the embodiment of the present application, a command cache area may be provided in the shared memory to write the read-write command to the shared memory into the command cache area when the sender device, the host controller, and the second accelerator do not have the control right of the shared memory.

In a specific implementation, a centralized command cache area may be provided in the shared memory to cache the read-write command to the shared memory generated by the sender device, the host controller, or the second accelerator when the control right of the shared memory is not obtained. Since the number of read-write commands generated by control subjects may be different, to avoid some control subjects occupying a large part of the command cache area, as shown in FIG. 2, the command cache area may be separately set for each control subject.

Then, the command cache area may include a first command cache area corresponding to the sender device, a second command cache area corresponding to the second accelerator, and a third command cache area corresponding to the host controller. The writing a read-write command to the shared memory into the command cache area when the sender device, the host controller, and the second accelerator do not have the control right of the shared memory may include: writing the read-write command to the shared memory into the corresponding command cache area when the sender device, the host controller, and the second accelerator do not have the control right of the shared memory, and writing the read-write command into the corresponding command cache area to cover a read-write command that is written earliest if the corresponding command cache area is fully written.

In addition, the overall size of the command cache area may also be adjusted according to requirements, or the size of the command cache area corresponding to each control subject may be separately adjusted. Then, the data processing method provided by the embodiment of the present application may further include: configuring a size of the first command cache area, a size of the second command cache area, and a size of the third command cache area according to an operating environment of the host.

In addition, an outdated read-write command is deleted in time by performing a deletion operation of the read-write commands in the command cache area. Specifically, a channel cache size register in the shared memory may be configured to define a duration for the first command cache area to cache the read-write command, a duration for the second command cache area to cache the read-write command, and a duration for the third command cache area to cache the read-write command. For example, the third command cache area may be set to cache only read-write commands generated by the host controller within the last three days, and to delete outdated read-write commands.

Based on this, after obtaining the control right of the shared memory, the sender device, the host controller, and the second accelerator may first check the command cache area, and execute, if the command cache area stores a locally sent unexecuted read-write command, a new read-write command after executing the unexecuted read-write command.

According to the data processing method provided by the embodiment of the present application, by providing the command cache area in the shared memory of the first accelerator, not only the sender device, the host controller, and the second accelerator may write the read-write command to the shared memory into the command cache area when not having the control right of the shared memory, but also the sender device, the host controller, and the second accelerator may have a buffering effect at the moment when losing the control right of the shared memory, so as to avoid the loss of the read-write command sent by the sender device, the host controller, or the second accelerator to the shared memory at this moment.

Embodiment 7 of the present application is described below.

In addition to dividing the command cache areas corresponding to the sender device, the host controller, and the second accelerator in the shared memory as described in the above-mentioned embodiment, a command cache area may also be provided in a local memory of each control subject. Then, in some implementations, the sender device, the host controller, and the second accelerator may write a read-write command to the shared memory into a local command cache area when not having the control right of the shared memory. After the read-write command to the shared memory is executed, the corresponding read-write command in the command cache area of the local memory may be deleted.

Then, the sender device, the second accelerator, and the host controller also cache the read-write command to the pre-divided command cache area in the local memory while sending the read-write command to the shared memory, so as to avoid data loss of the read-write command when there is no control right of the shared memory currently. Then, the sender device, the host controller, and the second accelerator may write the read-write command to the shared memory into the corresponding command cache area when not having the control right of the shared memory, and write the read-write command into the corresponding command cache area to cover a read-write command that is written earliest if the corresponding command cache area is fully written.

In addition, the overall size of the command cache area may also be adjusted according to requirements, or the size of the command cache area corresponding to each control subject may be separately adjusted.

Based on this, after obtaining the control right of the shared memory, the sender device, the host controller, and the second accelerator may first check the command cache area in the local memory, and execute, if the command cache area stores a locally sent unexecuted read-write command, a new read-write command after executing the unexecuted read-write command.

According to the data processing method provided by the embodiment of the present application, by providing the command cache area in the local memory of each of the sender device, the host controller, and the second accelerator and providing the command cache area in the host memory, not only the sender device, the host controller, and the second accelerator may write the read-write command to the shared memory into the command cache area in the local memory when not having the control right of the shared memory, but also the sender device, the host controller, and the second accelerator may have a buffering effect at the moment when losing the control right of the shared memory, so as to avoid the loss of the read-write command sent by the sender device, the host controller, or the second accelerator to the shared memory at this moment.

Embodiment 8 of the present application is described below.

Based on the above-mentioned embodiments, the embodiment of the present application provides a data processing method that facilitates implementation. In practical application, the host controller may initiate a thread corresponding to a computing task being performed by the second accelerator. If the host is installed with a plurality of second accelerators to simultaneously perform computing tasks, the host controller may initiate a plurality of threads to simultaneously perform the data processing method provided by the embodiment of the present application.

Taking the host controller running a first thread to control the computing task being performed by the second accelerator as an example, in the data processing method provided by the embodiment of the present application, the switching, when receiving a computing task, a control right of a shared memory of a first accelerator installed on a host to a sender device of the computing task based on a CXL protocol to cause the sender device to write to-be-processed data of the computing task into the shared memory based on an RDMA protocol in S401 may include:
configuring, when receiving a processing request of the computing task, a channel selection register of the shared memory based on the CXL protocol to enable a first data I/O channel corresponding to an RDMA network interface, and configuring the RDMA network interface based on the CXL protocol to initiate the RDMA network interface to receive and write the to-be-processed data into the shared memory.

Specifically, the host controller runs the first thread to configure a parameter of the channel selection register in the shared memory through a CXL channel constructed by the CXL module of the first accelerator, so as to enable an RDMA channel (i.e., the first data I/O channel) of the shared memory: Set_channel_reg(1).

The host controller runs the first thread to configure an RDMA module, and starts to receive the to-be-processed data of the computing task from a remote sender device.

First, buff is requested according to the size of the to-be-processed data:

$$buff = malloc\_recv ( length ) .$$

Then, the to-be-processed data is started to be received:
Rdma_start_recv(buff).

The switching the control right of the shared memory to a second accelerator installed on the host based on the CXL protocol to cause the second accelerator to read the to-be-processed data from the shared memory to execute the computing task and write a computation result into the shared memory in S402 may include the following steps.

The channel selection register of the shared memory is configured based on the CXL protocol to enable a third data I/O channel corresponding to the host controller to write a kernel model corresponding to the computing task into the shared memory based on the third data I/O channel.

Specifically, the host controller runs the first thread to configure the parameter of the channel selection register in the shared memory through the CXL channel, so as to enable the CXL channel (i.e., the third data I/O channel) of the shared memory:
Set_channel_reg(3).

The host controller runs the first thread to download a kernel program to the shared memory, and downloads a model parameter of the kernel program to the shared memory.

The kernel program is downloaded to the shared memory:
Gpu_Down_load(kernel).

The model parameter args is downloaded to the shared memory:
Gpu_set_kernel_args(args).

The channel selection register of the shared memory is configured based on the CXL protocol to enable a second data I/O channel corresponding to the second accelerator to cause the second accelerator to read the kernel model and the to-be-processed data from the shared memory to a local cache via the second data I/O channel to execute the computing task and write, after obtaining the computation result, the computation result into the shared memory based on the second data I/O channel.

Specifically, the host controller runs the first thread to configure the parameter of the channel selection register in the shared memory through the CXL channel, so as to enable a second accelerator channel (i.e., the second data I/O channel) of the shared memory:
Set_channel_reg(2).

The second accelerator is notified through a PCIe channel that computation may be performed.

A storage location in_buff of the kernel program and the to-be-processed data in the shared memory and a storage location out_buff of the computation result provided in the shared memory are passed to the second accelerator:
Gpu_kernel_start(kernel, in_buff, out_buff).

The switching, when the second accelerator completes the computing task, the control right of the shared memory to the sender device based on the CXL protocol to cause the sender device to read the computation result from the shared memory based on the RDMA protocol in S403 may include:
configuring, when receiving information of completing the computing task fed back by the second accelerator, the channel selection register of the shared memory based on the CXL protocol to enable the first data I/O channel, and configuring the RDMA network interface based on the CXL protocol to cause the sender device to read the computation result from the shared memory based on the RDMA protocol.

Alternatively, the host controller receives the computation result, and the switching the control right of the shared memory to the host controller based on the CXL protocol to cause the host controller to read the computation result from the shared memory in S403 may include: configuring, when receiving the information of completing the computing task fed back by the second accelerator, the channel selection register of the shared memory based on the CXL protocol to enable the third data I/O channel to read the computation result from the shared memory to the host controller based on the third data I/O channel.

Specifically, the host controller runs the first thread to wait for the second accelerator to complete the computation:
Wait_sem( ).

When receiving the information of completing the computing task fed back by the second accelerator when triggering an interruption, the host controller runs the first thread to configure the parameter of the channel selection register in the shared memory through the CXL channel, so as to enable the CXL channel (i.e., the third data I/O channel) of the shared memory:
Set_channel_reg(3).

The host controller runs the first thread to acquire the computation result from the shared memory:

$$out\_buff - Get\_gpu \_result ( ) .$$

Embodiment 9 of the present application is described below.

The above-mentioned embodiment describes the data processing method provided by the present application using the host controller of the host as an execution subject. For ease of understanding, the embodiment of the present application further provides a data processing method based on the first accelerator.

The data processing method provided by the embodiment of the present application is applied to the first accelerator of the host and includes:
switching, when receiving a first switching command sent by a host controller of the host based on a CXL protocol, a control right of a shared memory of the first accelerator to a sender device of a computing task to cause the sender device to write to-be-processed data of the computing task into the shared memory based on an RDMA protocol;
switching, when receiving a second switching command sent by the host controller based on the CXL protocol, the control right of the shared memory to a second accelerator installed on the host to cause the second accelerator to read the to-be-processed data from the shared memory to execute the computing task and write a computation result into the shared memory; and
switching, when receiving the first switching command sent by the host controller when the second accelerator completes the computing task based on the CXL protocol, the control right of the shared memory of the first accelerator to the sender device to cause the sender device to read the computation result from the shared memory based on the RDMA protocol; or switching, when receiving a third switching command sent by the host controller when the second accelerator completes the computing task based on CXL protocol, the control right of the shared memory of the first accelerator to the host controller to cause the host controller to read the computation result from the shared memory.

The first accelerator is a device that supports the CXL protocol and is configured to provide the shared memory to the sender device, the second accelerator, and the host controller. In practical application, referring to the description of embodiment 1 of the present application, the first accelerator establishes a CXL channel with the host controller based on the CXL protocol, whereby the host controller configures an RDMA module of the first accelerator and the shared memory of the first accelerator based on the CXL channel.

Further, the shared memory may be provided with a command cache area to write a read-write command to the shared memory into the command cache area when the sender device, the host controller, and the second accelerator do not have the control right of the shared memory.

It should be noted that the data processing method provided by the embodiment of the present application and the data processing device and data processing method provided by the above-mentioned embodiments correspond to each other. Specific implementations of the data processing method provided by the embodiment of the present application may refer to the description of the above-mentioned embodiments, and the above-mentioned embodiments may also refer to the description of the embodiments of the present application when being implemented.

Embodiment 10 of the present application is described below.

The above-mentioned embodiment describes the data processing method provided by the present application using the host controller of the host as an execution subject. For ease of understanding, the embodiment of the present application further provides a data processing method based on the second accelerator.

The data processing method provided by the embodiment of the present application is applied to the second accelerator of the host and includes:
reading, when receiving a computing task starting signal and obtaining a control right of a shared memory of a first accelerator installed on the host, to-be-processed data of a computing task from the shared memory to execute the computing task, and writing a computation result into the shared memory; and
notifying, when completing the computing task, a host controller of information of completing the computing task to cause the host controller to switch the control right of the shared memory to a sender device of the computing task based on a CXL protocol to cause the sender device to read the computation result from the shared memory based on an RDMA protocol, or switch the control right of the shared memory to the host controller based on the CXL protocol to cause the host controller to read the computation result from the shared memory,
where the to-be-processed data is written to the shared memory by the sender device based on the RDMA protocol after the host controller switches the control right of the shared memory to the sender device based on the CXL protocol.

The second accelerator is an accelerator on the host configured to execute the computing task. The second accelerator accesses the shared memory provided by the first accelerator on the host through a memory storage interface (e.g., a DDR synchronous dynamic random access memory interface). The second accelerator deploys a kernel model for performing the computing task in a local application computing logic kernel by receiving a kernel program provided by the host controller or the sender device. The kernel program may also be pre-written into the second accelerator to implement proprietary computing functions without waiting for the host controller to send the kernel program during the execution of the computing task.

It should be noted that the data processing method provided by the embodiment of the present application and the data processing device and data processing method provided by the above-mentioned embodiments correspond to each other. Specific implementations of the data processing method provided by the embodiment of the present application may refer to the description of the above-mentioned embodiments, and the above-mentioned embodiments may also refer to the description of the embodiments of the present application when being implemented.

Embodiment 11 of the present application is described below.

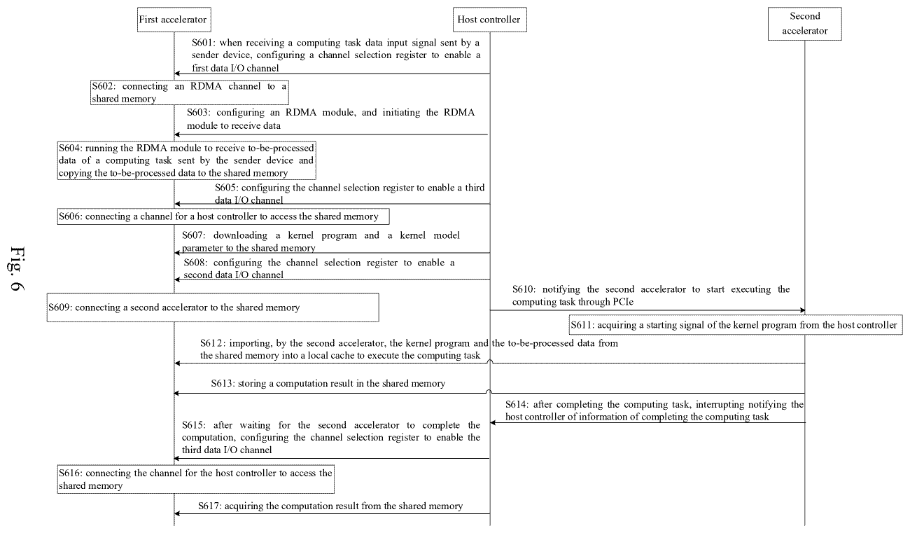

FIG. 6 is a flowchart of yet another data processing method provided by an embodiment of the present application.

Based on the above-mentioned embodiments, for ease of understanding, the embodiment of the present application further provides a data processing method, as shown in FIG. 6, including:
S601: when receiving a computing task data input signal sent by a sender device, configuring, by a host controller, a channel selection register to enable a first data I/O channel;
S602: connecting, by a first accelerator, an RDMA channel to a shared memory;
S603: configuring, by the host controller, an RDMA module, and initiating the RDMA module to receive data;
S604: running, by the first accelerator, the RDMA module to receive to-be-processed data of a computing task sent by the sender device and copying the to-be-processed data to the shared memory;
S605: configuring, by the host controller, the channel selection register to enable a third data I/O channel;
S606: connecting, by the first accelerator, a channel for a host controller to access the shared memory;
S607: downloading, by the host controller, a kernel program and a kernel model parameter to the shared memory;
S608: configuring, by the host controller, the channel selection register to enable a second data I/O channel;
S609: connecting, by the first accelerator, a second accelerator to the shared memory;
S610: notifying, by the host controller, the second accelerator to start executing the computing task through PCIe;
S611: acquiring, by the second accelerator, a starting signal of the kernel program from the host controller;
S612: importing, by the second accelerator, the kernel program and the to-be-processed data from the shared memory into a local cache to execute the computing task;
S613: storing, by the second accelerator, a computation result in the shared memory;
S614: after the second accelerator completes the computing task, interrupting notifying the host controller of information of completing the computing task;
S615: after waiting for the second accelerator to complete the computation, configuring, by the host controller, the channel selection register to enable the third data I/O channel;
S616: connecting, by the first accelerator, the channel for the host controller to access the shared memory; and
S617: acquiring, by the host controller, the computation result from the shared memory.

It should be noted that the data processing method provided by the embodiment of the present application and the data processing device and data processing method provided by the above-mentioned embodiments correspond to each other. Specific implementations of the data processing method provided by the embodiment of the present application may refer to the description of the above-mentioned embodiments, and the above-mentioned embodiments may also refer to the description of the embodiments of the present application when being implemented.

Various embodiments corresponding to the data processing method are described in detail above, and on this basis, the present application further discloses a data processing apparatus and device and a storage medium corresponding to the above-mentioned method.

Embodiment 12 of the present application is described below.

FIG. 7 is a schematic structural diagram of a data processing apparatus provided by an embodiment of the present application.

As shown in FIG. 7, the data processing apparatus provided by the embodiment of the present application is applied to a host controller and includes:
a task receiving control unit 701 configured to switch, when receiving a computing task, a control right of a shared memory of a first accelerator installed on a host to a sender device of the computing task based on a CXL protocol to cause the sender device to write to-be-processed data of the computing task into the shared memory based on a RDMA protocol;
a computation control unit 702 configured to switch the control right of the shared memory to a second accelerator installed on the host based on the CXL protocol to cause the second accelerator to read the to-be-processed data from the shared memory to execute the computing task and write a computation result into the shared memory; and
a result acquisition control unit 703 configured to switch, when the second accelerator completes the computing task, the control right of the shared memory to the sender device based on the CXL protocol to cause the sender device to read the computation result from the shared memory based on the RDMA protocol, or switch the control right of the shared memory to the host controller based on the CXL protocol to cause the host controller to read the computation result from the shared memory.

In some implementations, the task receiving control unit 701 switching the control right of the shared memory to the sender device based on the CXL protocol includes:
enabling an RDMA channel of the first accelerator based on the CXL protocol to connect the sender device to the shared memory based on the RDMA channel.

The computation control unit 702 switching the control right of the shared memory to the second accelerator based on the CXL protocol includes:
enabling a channel of the first accelerator to the second accelerator based on the CXL protocol to connect the second accelerator to the shared memory based on the channel to the second accelerator.

The result acquisition control unit 703 switching the control right of the shared memory to the host controller based on the CXL protocol includes:
enabling a channel of the first accelerator to the host controller based on the CXL protocol to connect the host controller to the shared memory based on the channel to the host controller.

In some implementations, the task receiving control unit 701 switching the control right of the shared memory to the sender device based on the CXL protocol includes:
enabling an RDMA module of the host, and controlling the first accelerator to connect the shared memory to the RDMA module based on the CXL protocol to connect the sender device to the shared memory based on the RDMA module.

In some implementations, the task receiving control unit 701 switching the control right of the shared memory to the sender device based on the CXL protocol includes:
configuring, based on the CXL protocol, a channel selection register of the shared memory in the first accelerator, and configuring a parameter of the channel selection register to open a first data I/O channel corresponding to the sender device and close a second data I/O channel corresponding to the second accelerator and a third data I/O channel corresponding to the host controller.

The computation control unit 702 switching the control right of the shared memory to the second accelerator based on the CXL protocol includes:
configuring, based on the CXL protocol, the channel selection register in the first accelerator, and configuring the parameter of the channel selection register to open the second data I/O channel corresponding to the second accelerator and close the first data I/O channel corresponding to the sender device and the third data I/O channel corresponding to the host controller.

The result acquisition control unit 703 switching the control right of the shared memory to the host controller based on the CXL protocol includes:
configuring, based on the CXL protocol, the channel selection register in the first accelerator, and configuring the parameter of the channel selection register to open the third data I/O channel corresponding to the host controller and close the first data I/O channel corresponding to the sender device and the second data I/O channel corresponding to the second accelerator.

In some implementations, the task receiving control unit 701 switching the control right of the shared memory to the sender device based on the CXL protocol includes:
configuring, based on the CXL protocol, the channel selection register of the shared memory in the first accelerator, and configuring the parameters of the channel selection register to switch a three-to-one channel switching switch in the first accelerator to conduct the sender device and the shared memory.
the computation control unit 702 switching the control right of the shared memory to the second accelerator based on the CXL protocol includes:
configuring, based on the CXL protocol, the channel selection register in the first accelerator, and configuring the parameter of the channel selection register to switch the three-to-one channel switching switch in the first accelerator to conduct the second accelerator and the shared memory.

The result acquisition control unit 703 switching the control right of the shared memory to the host controller based on the CXL protocol includes:
configuring, based on the CXL protocol, the channel selection register in the first accelerator, and configuring the parameter of the channel selection register to switch the three-to-one channel switching switch in the first accelerator to conduct the host controller and the shared memory.

In some implementations, the shared memory is provided with a command cache area to write a read-write command to the shared memory into the command cache area when the sender device, the host controller, and the second accelerator do not have the control right of the shared memory.

In some implementations, the command cache area includes a first command cache area corresponding to the sender device, a second command cache area corresponding to the second accelerator, and a third command cache area corresponding to the host controller; and
the writing a read-write command to the shared memory into the command cache area when the sender device, the host controller, and the second accelerator do not have the control right of the shared memory includes:
writing the read-write command to the shared memory into the corresponding command cache area when the sender device, the host controller, and the second accelerator do not have the control right of the shared memory, and writing the read-write command into the corresponding command cache area to cover a read-write command that is written earliest if the corresponding command cache area is fully written.

In some implementations, the data processing apparatus provided by the embodiment of the present application further includes:
a cache area configuration unit configured to configure a size of the first command cache area, a size of the second command cache area, and a size of the third command cache area according to an operating environment of the host.

In some implementations, after obtaining the control right of the shared memory, the sender device, the host controller, and the second accelerator check the command cache area, and execute, if the command cache area stores a locally sent unexecuted read-write command, a new read-write command after executing the unexecuted read-write command.

In some implementations, the sender device, the host controller, and the second accelerator write a read-write command to the shared memory into a local command cache area when not having the control right of the shared memory.

In some implementations, the second accelerator reading the to-be-processed data from the shared memory to execute the computing task and writing a computation result into the shared memory includes:
reading, by the second accelerator, the to-be-processed data from the shared memory to a local cache, inputting the to-be-processed data into a pre-deployed kernel model to obtain the computation result, and writing the computation result into the shared memory,
where the kernel model is written by the host controller to the shared memory after the host controller switches the control right of the shared memory to the host controller based on the CXL protocol.

In some implementations, the task receiving control unit 701 switching, when receiving a computing task, a control right of a shared memory of a first accelerator installed on a host to a sender device of the computing task based on a CXL protocol to cause the sender device to write to-be-processed data of the computing task into the shared memory based on a RDMA protocol includes:
configuring, when receiving a processing request of the computing task, a channel selection register of the shared memory based on the CXL protocol to enable a first data I/O channel corresponding to an RDMA network interface, and configuring the RDMA network interface based on the CXL protocol to initiate the RDMA network interface to receive and write the to-be-processed data into the shared memory.

The computation control unit 702 switching the control right of the shared memory to a second accelerator installed on the host based on the CXL protocol to cause the second accelerator to read the to-be-processed data from the shared memory to execute the computing task and write a computation result into the shared memory includes:
configuring the channel selection register of the shared memory based on the CXL protocol to enable a third data I/O channel corresponding to the host controller to write a kernel model corresponding to the computing task into the shared memory based on the third data I/O channel; and
configuring the channel selection register of the shared memory based on the CXL protocol to enable a second data I/O channel corresponding to the second accelerator, and notifying the second accelerator to execute the computing task based on PCIe to cause the second accelerator to read the kernel model and the to-be-processed data from the shared memory to a local cache via the second data I/O channel to execute the computing task and write, after obtaining the computation result, the computation result into the shared memory based on the second data I/O channel.

The result acquisition control unit 703 switching, when the second accelerator completes the computing task, the control right of the shared memory to the sender device based on the CXL protocol to cause the sender device to read the computation result from the shared memory based on the RDMA protocol includes:
configuring, when receiving the information of completing the computing task fed back by the second accelerator based on the PCIe, the channel selection register of the shared memory based on the CXL protocol to enable the first data I/O channel, and configuring the RDMA network interface based on the CXL protocol to cause the sender device to read the computation result from the shared memory based on the RDMA protocol.

The switching the control right of the shared memory to the host controller based on the CXL protocol to cause the host controller to read the computation result from the shared memory includes:
configuring, when receiving the information of completing the computing task fed back by the second accelerator based on the PCIe, the channel selection register of the shared memory based on the CXL protocol to enable the third data I/O channel to read the computation result from the shared memory to the host controller based on the third data I/O channel.

In some implementations, the first accelerator is a FPGA supporting the CXL protocol and having an extended memory or an ASIC supporting the CXL protocol and having an extended memory, and the second accelerator is a GPU; the extended memory serves as the shared memory of the first accelerator.

In some implementations, a plurality of GPUs share the shared memory of the same first accelerator.

Since the embodiment of the apparatus and the embodiment of the method correspond to each other, the embodiment of the device may refer to the description of the embodiment of the method, which will not be repeated here.

Embodiment 13 of the present application is described below.

Based on the above-mentioned embodiments, the embodiment of the present application provides a data processing apparatus.

The data processing apparatus provided by the embodiment of the present application is applied to the first accelerator of the host and includes:
a data import unit configured to switch, when receiving a first switching command sent by a host controller of the host based on a CXL protocol, a control right of a shared memory of the first accelerator to a sender device of a computing task to cause the sender device to write to-be-processed data of the computing task into the shared memory based on an RDMA protocol;
a computation auxiliary unit configured to switch, when receiving a second switching command sent by the host controller based on the CXL protocol, the control right of the shared memory to a second accelerator installed on the host to cause the second accelerator to read the to-be-processed data from the shared memory to execute the computing task and write a computation result into the shared memory; and
a computation result export unit configured to switch, when receiving the first switching command sent by the host controller when the second accelerator completes the computing task based on the CXL protocol, the control right of the shared memory of the first accelerator to the sender device to cause the sender device to read the computation result from the shared memory based on the RDMA protocol; or switch, when receiving a third switching command sent by the host controller when the second accelerator completes the computing task based on CXL protocol, the control right of the shared memory of the first accelerator to the host controller to cause the host controller to read the computation result from the shared memory.

In some implementations, the shared memory is provided with a command cache area to write a read-write command to the shared memory into the command cache area when the sender device, the host controller, and the second accelerator do not have the control right of the shared memory.

Since the embodiment of the apparatus and the embodiment of the method correspond to each other, the embodiment of the device may refer to the description of the embodiment of the method, which will not be repeated here.

Embodiment 14 of the present application is described below.

Based on the above-mentioned embodiments, the embodiment of the present application provides a data processing apparatus.

The data processing apparatus provided by the embodiment of the present application is applied to the second accelerator of the host and includes:
a computation unit configured to read, when receiving a computing task starting signal and obtaining a control right of a shared memory of a first accelerator installed on the host, to-be-processed data of a computing task from the shared memory to execute the computing task, and write a computation result into the shared memory; and
a computation result feedback unit configured to notify, when completing the computing task, a host controller of information of completing the computing task to cause the host controller to switch the control right of the shared memory to a sender device of the computing task based on a CXL protocol to cause the sender device to read the computation result from the shared memory based on an RDMA protocol, or switch the control right of the shared memory to the host controller based on the CXL protocol to cause the host controller to read the computation result from the shared memory,
where the to-be-processed data is written to the shared memory by the sender device based on the RDMA protocol after the host controller switches the control right of the shared memory to the sender device based on the CXL protocol.

Since the embodiment of the apparatus and the embodiment of the method correspond to each other, the embodiment of the device may refer to the description of the embodiment of the method, which will not be repeated here.

Embodiment 15 of the present application is described below.

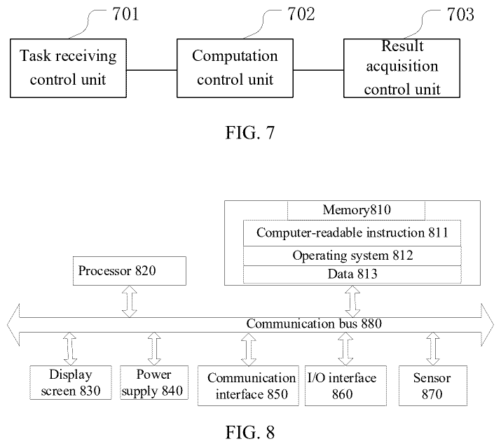

FIG. 8 is a schematic structural diagram of another data processing device provided by an embodiment of the present application.

Unlike the data processing device provided by embodiment 1 of the present application, the embodiment of the present application provides another data processing device configured to perform the data processing method provided by the embodiment of the present application.

As shown in FIG. 8, the data processing device provided by the embodiment of the present application includes:
a memory 810 configured to store a computer-readable instruction 811; and
a processor 820 configured to execute the computer-readable instruction 811 which, when executed by the processor 820, implement the steps of the data processing method according to any one of the above-mentioned embodiments.

The processor 820 may include one or more processing cores, for example, a 3-core processor or an 8-core processor. The processor 820 may be implemented in at least one hardware form of digital signal processing (DSP), an FPGA, and a programmable logic array (PLA). The processor 820 may further include a main processor and a coprocessor. The main processor is a processor configured to process data in an awake state and is also referred to as a CPU. The coprocessor is a low-power-consumption processor configured to process data in a standby state. In some embodiments, the processor 820 may be integrated with a GPU. The GPU is configured to render and draw content that needs to be displayed on a display screen. In some embodiments, the processor 820 may further include an AI processor. The AI processor is configured to process computing operations related to machine learning.

The memory 810 may include one or more storage media, which may be non-transient. The memory 810 may further include a high-speed random access memory (RAM) and a nonvolatile memory, for example, one or more disk storage devices or flash storage devices. In this embodiment, the memory 810 is configured to store at least the following computer-readable instruction 811 which, when loaded and executed by the processor 820, can implement the relevant steps in the data processing method disclosed in any one of the foregoing embodiments. In addition, resources stored in the memory 810 may include an operating system 812, data 813, and the like. The storage manner may be temporary storage or permanent storage. The operating system 812 may be Windows. The data 813 may include, but is not limited to, data related to the above-mentioned method.

In some embodiments, the data processing device may further include a display screen 830, a power supply 840, a communication interface 850, a I/O interface 860, a sensor 870, and a communication bus 880.

A person skilled in the art may understand that the structure shown in FIG. 8 constitutes no limitation on the data processing device and may include more or fewer assemblies than those shown in the figure.

The data processing device provided by the embodiment of the present application includes a memory and a processor which, when executing the computer-readable instruction stored in the memory, can implement the data processing method as described above with the same effect as above.

Embodiment 16 of the present application is described below.

It should be noted that the foregoing apparatus and device embodiments are merely illustrative. For example, the division of modules is merely logical function division and may be other division in actual implementations. For example, a plurality of modules or assemblies may be combined or integrated into another system, or some features may be ignored or not performed. In addition, the displayed or discussed mutual couplings, direct couplings, or communication connections may be indirect couplings or communication connections through some interfaces, apparatuses, or modules, and may be electrical, mechanical, or otherwise. The modules described as separate components may or may not be physically separated, and the components displayed as modules may or may not be physical modules, i.e., may be located in one place or may be distributed over a plurality of network modules. Some or all of the modules may be selected according to actual needs to achieve the object of the solutions of the embodiments.

In addition, functional modules in the embodiments of the present application may be integrated in one processing module, or each module may physically exist separately, or two or more modules may be integrated in one module. The above-mentioned integrated modules may be implemented in the form of hardware or in the form of software functional modules.

The integrated modules, if implemented in the form of software functional modules and sold or used as stand-alone products, may be stored in a storage medium. Based on such understanding, the technical solution of the present application, in essence, or in the part that makes contributions to the related art, or the entirety or part of the technical solution may be embodied in the form of a software product. The computer software product is stored in a storage medium to perform all or part of the steps of the method according to various embodiments of the present application.

To this end, the embodiment of the present application further provides one or more non-volatile computer-readable storage media, storing a computer-readable instruction which, when executed by one or more processors, implements the steps of the data processing method.

The storage medium includes various media capable of storing a program code, such as a USB flash disk, a removable hard disk, a (read-only memory) ROM, a RAM, a magnetic disk, or an optical disk.

The computer-readable instruction contained in the storage medium provided in this embodiment can implement the steps of the data processing method as described above when executed by the processor, with the same effect as above.

The data processing method, apparatus, and device, the storage medium, and the distributed cluster provided by the present application are described in detail above. Various embodiments are described in the specification in a progressive manner, with each embodiment focusing on differences from the other embodiments. The identical or similar parts among the various embodiments may be referred to each other. For the apparatus, device, storage medium, and distributed cluster disclosed in the embodiments, since they correspond to the method disclosed in the embodiment, their descriptions are relatively simple, and relevant parts may refer to the description in the method section. It should be noted that for a person skilled in the art, several improvements and modifications may be made without departing from the principles of the present application, and these improvements and modifications fall within the scope of the present application.

It should be further noted that relational terms such as “first” and “second” in the specification are used only for distinguishing one entity or operation from another entity or operation without necessarily requiring or implying any actual such relationships or orders among these entities or operations. Furthermore, the terms “comprise”, “contain”, or any other variation thereof are intended to cover a non-exclusive inclusion, whereby a process, method, article, or device that includes a list of elements does not include only those elements but may include other elements not expressly listed or inherent to such process, method, article, or device. An element limited by the phrase “comprise a . . . ” does not, without more constraints, preclude the existence of additional identical elements in the process, method, article, or device that includes the element.

1. A data processing method, being applied to a host controller and comprising:
switching, in response to receiving a computing task, a control right of a shared memory of a first accelerator installed on a host to a sender device of the computing task based on a compute express link (CXL) protocol to cause the sender device to write to-be-processed data of the computing task into the shared memory based on a remote direct memory access (RDMA) protocol;
switching the control right of the shared memory to a second accelerator installed on the host based on the CXL protocol to cause the second accelerator to read the to-be-processed data from the shared memory to execute the computing task and write a computation result into the shared memory; and
switching, in response to the second accelerator completing the computing task, the control right of the shared memory to the sender device based on the CXL protocol to cause the sender device to read the computation result from the shared memory based on the RDMA protocol, or switching the control right of the shared memory to the host controller based on the CXL protocol to cause the host controller to read the computation result from the shared memory.

2. The data processing method according to claim 1, wherein switching the control right of the shared memory to the sender device based on the CXL protocol comprises:
enabling an RDMA channel of the first accelerator based on the CXL protocol to connect the sender device to the shared memory based on the RDMA channel;
switching the control right of the shared memory to the second accelerator based on the CXL protocol comprises:
enabling a channel of the first accelerator to the second accelerator based on the CXL protocol to connect the second accelerator to the shared memory based on the channel to the second accelerator;
switching the control right of the shared memory to the host controller based on the CXL protocol comprises:
enabling a channel of the first accelerator to the host controller based on the CXL protocol to connect the host controller to the shared memory based on the channel to the host controller.

3. (canceled)

4. The data processing method according to claim 1, wherein switching the control right of the shared memory to the sender device based on the CXL protocol comprises:
configuring, based on the CXL protocol, a parameter of a channel selection register of the shared memory in the first accelerator to switch the control right of the shared memory to the sender device;
switching the control right of the shared memory to the second accelerator based on the CXL protocol comprises:
configuring, based on the CXL protocol, the parameter of the channel selection register of the shared memory in the first accelerator to switch the control right of the shared memory to the second accelerator;
switching the control right of the shared memory to the host controller based on the CXL protocol comprises:
configuring, based on the CXL protocol, the parameter of the channel selection register of the shared memory in the first accelerator to switch the control right of the shared memory to the host controller.

5. The data processing method according to claim 4, wherein the configuring, based on the CXL protocol, a parameter of a channel selection register of the shared memory in the first accelerator to switch the control right of the shared memory to the sender device comprises:
configuring, based on the CXL protocol, the parameter of the channel selection register of the shared memory in the first accelerator to open a first data input/output (I/O) channel corresponding to the sender device and close a second data I/O channel corresponding to the second accelerator and a third data I/O channel corresponding to the host controller;
the configuring, based on the CXL protocol, the parameter of the channel selection register of the shared memory in the first accelerator to switch the control right of the shared memory to the second accelerator comprises:
configuring, based on the CXL protocol, the parameter of the channel selection register of the shared memory in the first accelerator to open the second data I/O channel corresponding to the second accelerator and close the first data I/O channel corresponding to the sender device and the third data I/O channel corresponding to the host controller;
the configuring, based on the CXL protocol, the parameter of the channel selection register of the shared memory in the first accelerator to switch the control right of the shared memory to the host controller comprises:
configuring, based on the CXL protocol, the parameter of the channel selection register of the shared memory in the first accelerator to open the third data I/O channel corresponding to the host controller and close the first data I/O channel corresponding to the sender device and the second data I/O channel corresponding to the second accelerator.

6. The data processing method according to claim 4, wherein the configuring, based on the CXL protocol, a parameter of a channel selection register of the shared memory in the first accelerator to switch the control right of the shared memory to the sender device comprises:
configuring, based on the CXL protocol, the parameter of the channel selection register of the shared memory in the first accelerator to switch a three-to-one channel switching switch in the first accelerator to conduct the sender device and the shared memory;
the configuring, based on the CXL protocol, the parameter of the channel selection register of the shared memory in the first accelerator to switch the control right of the shared memory to the second accelerator comprises:
configuring, based on the CXL protocol, the parameter of the channel selection register of the shared memory in the first accelerator to switch the three-to-one channel switching switch in the first accelerator to conduct the second accelerator and the shared memory;
the configuring, based on the CXL protocol, the parameter of the channel selection register of the shared memory in the first accelerator to switch the control right of the shared memory to the host controller comprises:
configuring, based on the CXL protocol, the parameter of the channel selection register of the shared memory in the first accelerator to switch the three-to-one channel switching switch in the first accelerator to conduct the host controller and the shared memory.

7. The data processing method according to claim 1, wherein the shared memory is provided with a command cache area to write a read-write command to the shared memory into the command cache area when the sender device, the host controller, and the second accelerator do not have the control right of the shared memory.

8. The data processing method according to claim 7, wherein the command cache area comprises a first command cache area corresponding to the sender device, a second command cache area corresponding to the second accelerator, and a third command cache area corresponding to the host controller:
the writing a read-write command to the shared memory into the command cache area when the sender device, the host controller, and the second accelerator do not have the control right of the shared memory comprises:
writing the read-write command to the shared memory into the corresponding command cache area when the sender device, the host controller, and the second accelerator do not have the control right of the shared memory, and writing the read-write command into the corresponding command cache area to cover a read-write command that is written earliest if the corresponding command cache area is fully written.

9. The data processing method according to claim 8, wherein further comprising:
configuring a size of the first command cache area, a size of the second command cache area, and a size of the third command cache area according to an operating environment of the host.

10. The data processing method according to claim 7, wherein after obtaining the control right of the shared memory, the sender device, the host controller, and the second accelerator check the command cache area, and execute, if the command cache area stores a locally sent unexecuted read-write command, a new read-write command after executing the unexecuted read-write command.

11. The data processing method according to claim 1, wherein the sender device, the host controller, and the second accelerator write a read-write command to the shared memory into a local command cache area when not having the control right of the shared memory.

12. The data processing method according to claim 1, wherein the second accelerator reading the to-be-processed data from the shared memory to execute the computing task and writing a computation result into the shared memory comprises:
reading, by the second accelerator, the to-be-processed data from the shared memory to a local cache, inputting the to-be-processed data into a pre-deployed kernel model to obtain the computation result, and writing the computation result into the shared memory,
wherein the kernel model is written by the host controller to the shared memory after the host controller switches the control right of the shared memory to the host controller based on the CXL protocol.

13. The data processing method according to claim 1, wherein the switching, in response to receiving a computing task, a control right of a shared memory of a first accelerator installed on a host to a sender device of the computing task based on a CXL protocol to cause the sender device to write to-be-processed data of the computing task into the shared memory based on an RDMA protocol comprises:
configuring, in response to receiving a processing request of the computing task, a channel selection register of the shared memory based on the CXL protocol to enable a first data I/O channel corresponding to an RDMA network interface, and configuring the RDMA network interface based on the CXL protocol to initiate the RDMA network interface to receive and write the to-be-processed data into the shared memory;
the switching the control right of the shared memory to a second accelerator installed on the host based on the CXL protocol to cause the second accelerator to read the to-be-processed data from the shared memory to execute the computing task and write a computation result into the shared memory comprises:
configuring the channel selection register of the shared memory based on the CXL protocol to enable a third data I/O channel corresponding to the host controller to write a kernel model corresponding to the computing task into the shared memory based on the third data I/O channel; and
configuring the channel selection register of the shared memory based on the CXL protocol to enable a second data I/O channel corresponding to the second accelerator to cause the second accelerator to read the kernel model and the to-be-processed data from the shared memory to a local cache via the second data I/O channel to execute the computing task and write, after obtaining the computation result, the computation result into the shared memory based on the second data I/O channel;
the switching, in response to the second accelerator completing the computing task, the control right of the shared memory to the sender device based on the CXL protocol to cause the sender device to read the computation result from the shared memory based on the RDMA protocol comprises:
configuring, in response to receiving information of completing the computing task fed back by the second accelerator, the channel selection register of the shared memory based on the CXL protocol to enable the first data I/O channel, and configuring the RDMA network interface based on the CXL protocol to cause the sender device to read the computation result from the shared memory based on the RDMA protocol;
the switching the control right of the shared memory to the host controller based on the CXL protocol to cause the host controller to read the computation result from the shared memory comprises:
configuring, in response to receiving the information of completing the computing task fed back by the second accelerator, the channel selection register of the shared memory based on the CXL protocol to enable the third data I/O channel to read the computation result from the shared memory to the host controller based on the third data I/O channel.

14. The data processing method according to claim 1, wherein the first accelerator is a field-programmable gate array (FPGA) supporting the CXL protocol and having an extended memory or an application specific integrated circuit (ASIC) supporting the CXL protocol and having an extended memory, and the second accelerator is a graphics processing unit (GPU): the extended memory serves as the shared memory of the first accelerator.

15. (canceled)

16. A data processing method, being applied to a first accelerator of a host and comprising:
switching, in response to receiving a first switching command sent by a host controller of the host based on a compute express link (CXL) protocol, a control right of a shared memory of the first accelerator to a sender device of a computing task to cause the sender device to write to-be-processed data of the computing task into the shared memory based on a remote direct memory access (RDMA) protocol;
switching, in response to receiving a second switching command sent by the host controller based on the CXL protocol, the control right of the shared memory to a second accelerator installed on the host to cause the second accelerator to read the to-be-processed data from the shared memory to execute the computing task and write a computation result into the shared memory; and
switching, in response to receiving the first switching command sent by the host controller when the second accelerator completes the computing task based on the CXL protocol, the control right of the shared memory of the first accelerator to the sender device to cause the sender device to read the computation result from the shared memory based on the RDMA protocol: or switching, in response to receiving a third switching command sent by the host controller when the second accelerator completes the computing task based on CXL protocol, the control right of the shared memory of the first accelerator to the host controller to cause the host controller to read the computation result from the shared memory.

17. The data processing method according to claim 16, wherein the shared memory is provided with a command cache area to write a read-write command to the shared memory into the command cache area when the sender device, the host controller, and the second accelerator do not have the control right of the shared memory.

18. A data processing method, being applied to a second accelerator of a host and comprising:
reading, in response to receiving a computing task starting signal and obtaining a control right of a shared memory of a first accelerator installed on the host, to-be-processed data of a computing task from the shared memory to execute the computing task, and writing a computation result into the shared memory; and
notifying, in response to completing the computing task, a host controller of information of completing the computing task to cause the host controller to switch the control right of the shared memory to a sender device of the computing task based on a compute express link (CXL) protocol to cause the sender device to read the computation result from the shared memory based on a remote direct memory access (RDMA) protocol, or switch the control right of the shared memory to the host controller based on the CXL protocol to cause the host controller to read the computation result from the shared memory,
wherein the to-be-processed data is written to the shared memory by the sender device based on the RDMA protocol after the host controller switches the control right of the shared memory to the sender device based on the CXL protocol.

19. A data processing device, comprising a host controller, a first accelerator, and a second accelerator,
wherein the first accelerator establishes a compute express link (CXL) channel with the host controller based on a CXL protocol to realize a shared memory of the first accelerator;
the host controller implements the steps of the data processing method according to claim 1.

20. A distributed cluster, comprising the data processing device according to claim 19.

21. (canceled)

22. A data processing device, comprising:
a memory configured to store a computer-readable instruction; and
a processor configured to execute the computer-readable instruction which, when executed by the processor, implements the steps of the data processing method according to claim 1.

23. One or more non-volatile computer-readable storage media, storing a computer-readable instruction which, when executed by one or more processors, causes the one or more processors to perform the steps of the method according to claim 1.
